(19) United States
(12) Patent Application Publication
(10) Pub. No.: US 2026/0149930 A1
(43) Pub. Date: May 28, 2026

(54) ROBUST ELECTROACOUSTIC TRANSDUCER

(71) Applicant: GOOGLE LLC, Mountain View, CA (US)

(72) Inventors: Timothy A. GLADWIN, Mountain View, CA (US); Jesse Alexander LIPPERT, Mountain View, CA (US)

(21) Appl. No.: 19/121,523

(22) PCT Filed: Jan. 20, 2023
(86) PCT No.: PCT/US2023/011272

§ 371 Date: Apr. 16, 2025

(51) Int. Cl. H04R 7/20; H04R 1/02; H04R 7/04; H04R 9/02; H04R 9/06

(52) U.S. Cl. CPC H04R 7/20; H04R 1/023; H04R 7/04; H04R 9/025; H04R 9/06

(57) ABSTRACT

In general, the subject matter described in this disclosure references technologies related to an electroacoustic transducer that comprises: a magnetic circuit that defines an air gap; a diaphragm; a voice coil that is attached to the diaphragm and extends into the air gap defined by the magnetic circuit; a peripheral support structure; and a surround that is flexible and connects the diaphragm to the peripheral support structure, to provide suspension for the diaphragm and enable the diaphragm to oscillate responsive to electrical activation of the voice coil, wherein the surround and the peripheral support structure are shaped such that a portion of the surround that is suspended in air when the diaphragm is in a rest state comes into contact with a lower landing surface of the peripheral support structure when the diaphragm oscillates responsive to electrical activation of the voice coil.

### TECHNICAL FIELD

This document relates to electroacoustic transducers.

### BACKGROUND

An electroacoustic transducer is a device that converts an electrical audio signal into pressure waves that form audible sounds. Traditional electroacoustic transducers, especially those located within wearable devices (often called micro speakers), do not operate adequately after being exposed to extreme environmental conditions. For example, such micro speakers may provide inadequate sound pressure levels, offer limited sound quality, require substantial time to recover from changes in air pressure and liquid immersion, and are often unable to eject liquid following liquid immersion. Liquid immersion is likely for micro speakers that are integrated into a wrist-worn wearable device, resulting from users swimming, washing their hands, and/or spilling liquids onto their hands.

### SUMMARY

This document describes systems, methods, and other technologies related to electroacoustic transducers.

Some electroacoustic transducer configurations presented in this disclosure include a multi-functional seal component that includes both (1) a seal portion that adapted to form a seal between the transducer and a housing in which the transducer is located, and (2) a surround portion that attaches a diaphragm of the transducer to a peripheral support structure of the transducer. The multi-functional seal component may be formed of a single material, such as an elastomer, such that the seal portion and the surround portion are formed from a unitary elastomer component.

Providing a transducer seal and a transducer surround with a unitary component enhances a liquid resistance of the transducer. The seal portion may include a flexible seal lip that is compressed inward toward a remainder of the transducer when the transducer is placed into a recess of the housing that is sized to receive the transducer. Integrating a lip seal into the transducer eliminates a need for a separate O-ring or D-ring to seal the transducer to a housing, and potential complications that can result from fabricating an O-ring and installing the O-ring onto the transducer. Moreover, implementing a lip seal results in a single sealing junction between the transducer and the housing (e.g., a closed curving sealing junction, such as a circle or ellipse), in contrast to use of an O-ring that results in two sealing junctions between the transducer and the housing—on the outer and inner sides of the O-ring.

Some transducer configurations include a diaphragm that defines an aperture that extends through the diaphragm (e.g., located at a center of the diaphragm), with a barometric vent attached directly or indirectly to the diaphragm at a location aligned with the aperture. Implementing a barometric vent at the location of an aperture in the diaphragm can enable the transducer to prevent water ingress into an internal space of the transducer (e.g., with the internal space including an air gap provided by a magnetic circuit of the transducer and including space between the diaphragm and the magnetic circuit).

Yet still, a barometric vent attached to the diaphragm enables equalization of a pressure in the internal space of the transducer with an atmospheric pressure external to the transducer (e.g., over a period of at least a minute). Such one or more barometric vents attached to the diaphragm may be the only one or more paths for air to enter the internal space of the transducer, such that sides and a rear surface of the transducer may be sealed from air entry. As such, the transducer may be entirely sealed from liquid ingress to the internal space of the transducer.

Some transducer configurations include lower and/or upper landing surfaces that are shaped for contact by the surround portion during oscillation of the diaphragm. The surround portion may have a curved shape, and may “unroll” as the diaphragm moves toward or away from the electrical circuit. A portion of the surround that is suspended in air during a rest state of the diaphragm and not in contact with either of the lower and upper landing surfaces may unroll and come into contact with the lower and/or upper landing surfaces during diaphragm movement.

Providing lower and/or upper landing surfaces that are adapted to come in contact with and support the surround portion during diaphragm oscillation limits stretching of the surround portion during operation of the transducer within a configured electro-magnetic operating range of the transducer (e.g., within a range of voltages that the voice coil is adapted to receive and an amplifier is adapted to provide).

Moreover, such lower and/or upper landing surfaces provide support for the surround portion to prevent the surround portion from stretching outward—away from a center of the diaphragm—responsive to pressure that may be exerted on the surround portion by liquids. The lower and/or upper landing surfaces also provide support to the surround portion that limits an amount of curvature of the surround during transducer operation. For example, the lower and/or upper landing surfaces can prevent what otherwise may be severe bending of the surround portion proximate a location that the surround attaches to the peripheral support structure, maintaining long-term integrity of a material from which the surround is formed.

Some transducer configurations include lower and/or upper stops adapted to prevent excursion of the diagram to a level that damages the surround and/or results in viscoelastic creep that stretches the surround an amount that affects transducer sound quality for a semi-permanent or permanent period of time. The surround may be adapted to provide a linear spring constant return force within the electro-magnetic operating range of the transducer.

Should a pressure imparted upon the diaphragm by fluid exceed forces imparted upon the diaphragm by the voice coil that occur during the configured electro-magnetic operating range of the transducer, the lower and/or upper stops are located a relatively-short distance from the outermost excursion of the diaphragm during the configured electro-magnetic operating range of the transducer, such that the surround portion only stretches a relatively modest, non-destructive, and recoverable amount beyond an amount typical during within the configured electro-magnetic operating range of the transducer.

While the surround may provide a linear return force for transducer operation within the configured electro-magnetic operating range of the transducer, stretch of the surround portion that results from excessive force imparted by external fluid generates a return force that is greater than the linear return force. This larger return force assists evacuating liquid from a space between the diaphragm and a protective mesh located in front of the transducer (e.g., opposite the transducer from the magnetic circuit).

Some transducer configurations include a secondary suspension, in addition to the suspension provided by the surround portion. This secondary suspension may be located behind the diaphragm (e.g., proximate the magnetic circuit), and may provide a return force that assists the diaphragm in returning to its rest state.

The secondary suspension may be provided by one or more springs located in the air gap formed by the magnetic circuit, and may impart force upon a bottom of the voice coil. The secondary suspension may be attached to the voice coil during its rest state, and may expand and contract as the voice coil oscillates with the diaphragm. The secondary suspension may also remain unattached to the voice coil and diaphragm, and come into contact with the voice coil and/or diaphragm upon the diaphragm being forced to limits of its innermost or outermost excursion.

The details of one or more implementations are set forth in the accompanying drawings and the description below. Other features, objects, and advantages will be apparent from the description and drawings, and from the claims.

### DESCRIPTION OF DRAWINGS

FIGS. 1A-D show different views of a first electroacoustic transducer embodiment.

FIGS. 2A-B show insertion of the first electroacoustic transducer embodiment into a housing.

FIGS. 3A-B show insertion of a second electroacoustic transducer embodiment into a housing.

FIGS. 4-6 show close-up views of portions of three electroacoustic transducer embodiments.

FIGS. 7A-B show maximum excursion of the first electroacoustic transducer embodiment that results from configured electro-magnetic operation.

FIGS. 8A-B show maximum excursion of the first electroacoustic transducer embodiment resulting from pressures in excess of the configured electro-magnetic operation.

FIG. 9 shows maximum excursion of a fourth electroacoustic transducer embodiment resulting from configured electro-magnetic operation.

FIG. 10 shows a fifth electroacoustic transducer embodiment that includes various secondary suspension components.

Like reference numbers in the various drawings indicate like elements.

### DETAILED DESCRIPTION

This disclosure describes various different electroacoustic transducer configurations. Such transducer configurations include features that reduce or eliminate issues with transducer operation that may occur upon fluid interacting with the transducer, for example, with fluid pressures that exceed those experienced by a transducer operating under standard conditions. One such feature is the use of a peripheral seal that is integrated into the transducer rather than being a separate component added to the transducer. The peripheral seal may be integral with the transducer surround that provides suspension for the transducer diaphragm, to limit the ability of water to enter an interior space of the transducer or flow past sides of the transducer and enter interior spaces of a device in which the transducer is mounted.

Another such feature is the presence of one or more landing surfaces onto which the transducer surround comes into contact during oscillation of the diaphragm. Yet another such feature is one or more stopping surfaces that limit an extent of inward and/or outward excursion of the diaphragm, should the diaphragm experience forces that are stronger than those generated by the magnetic circuit of the transducer. The transducer may include a secondary suspension, in addition the suspension provided by the surround, to assist the diaphragm in returning from the limits of its excursion (e.g., as a result of the diaphragm coming into contact with an end stops due to a liquid compressing the diaphragm).

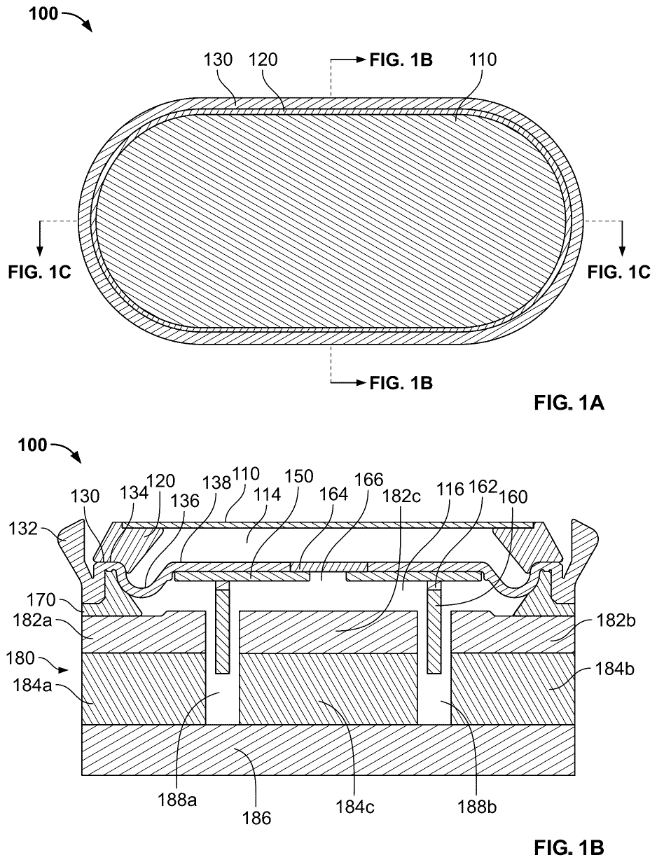

Various transducer assemblies that implement the above-referenced features are described below with reference to FIGS. 1A through 10.

FIGS. 1A-D show four different views of an electroacoustic transducer 100, with FIG. 1A showing a top view of the transducer 100. The transducer 100 shown in FIG. 1A has a “race track” shape, but the transducer 100 may have a different shape (e.g., a circular or oval shape). The top surface of the transducer that is shown in FIG. 1A may have dimensions of 14 mm by 6 mm, 16 mm by 6 mm, 13 mm by 6 mm, 12 mm by 6 mm, 13 mm by 4 mm, or any combination where the length ranges from 12 mm to 18 mm and the width ranges from 4 mm to 6 mm.

The transducers disclosed herein may have an effective moving area of the diaphragm, Sd (as defined by the peak of the surround roll at rest), greater than 65% of the projected area (e.g., 69%, for an efficiency gain of 3.5 dB) of the transducer as defined by an outer periphery of the transducer. This is in comparison to traditional electroacoustic transducers, which typically achieve about 40% of the transducer projected area (and which may only have a gain of 1.6 dB). Having a sizable effective moving area is valuable for speaker efficiency, as the area is squared in the acoustic efficiency equation.

The top view of transducer 100 shows a protective mesh 110, a mesh-supporting component 120, and a multi-functional seal component 130. The characteristics and functionality provided by these components are described in additional detail with reference to the sectional views discussed below.

FIG. 1B shows a side sectional view of the transducer 100, with the sectional view passing through a short axis of the transducer 100, as illustrated by the reference line in FIG. 1A that is labelled “FIG. 1B”. A depth of the transducer 100 in an up-down direction in FIG. 1B may be 3.2 mm or more generally within the range from 2.0 mm to 3.5 mm.

The protective mesh 110 provides a top surface to the transducer 100, and is supported by the mesh-supporting component 120, for example, with the mesh-supporting component 120 being molded over the protective mesh 110. The mesh 110 protects other components of the transducer from dust and/or larger objects that may contact a top surface of the transducer 100. For example, the mesh 110 may limit ingress of metal particles and reduce the impact of high pressure from water exposure. The mesh 110 may be coated or treated with hydrophobic and or hydrophilic coatings, and may be configured to facilitate free movement of air and liquid (e.g., to enable ejection of liquid from a space 114 below the mesh 110). The mesh 110 may be used to tune the acoustic response of the transducer.

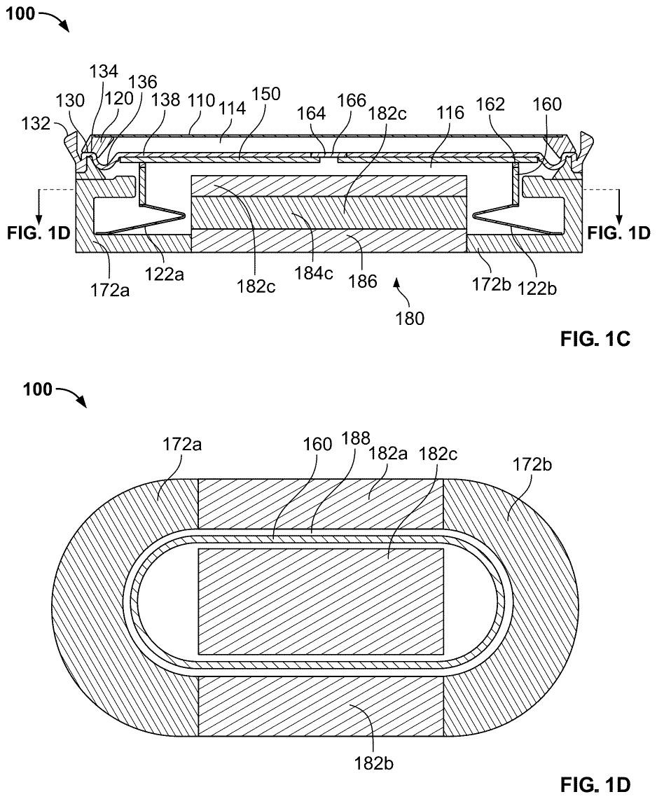

The multi-functional seal component 130 includes at least four portions: (1) a seal portion 132, (2) a peripheral-support-connection portion 134, (3) a surround portion 136, and (4) a diaphragm-connection portion 138. The seal portion 132 is configured to form a seal between the transducer 100 and a housing into which the transducer 100 is placed. The peripheral-support-connection portion 134 extends between the seal portion 132 and the surround portion 136, and is adapted to anchor the multi-functional seal component 130 to a peripheral support structure 170. The structure and function of the seal portion 132 and the peripheral-support-connection portion 134 are described with additional detail below, for example, with reference to FIGS. 2A-B and 4.

The surround portion 136 of the multi-functional seal component 130 comprises a rim of flexible material that attaches a diaphragm 150 to the peripheral support structure 170. The surround portion 136 provides at least the functionality of a traditional speaker “surround”, providing suspension for the diaphragm 150 and enabling the diaphragm 150 to oscillate and thereby produce sound waves.

The diaphragm-connection portion 134 attaches directly or indirectly through an intervening component to the diaphragm 150. FIG. 1B shows the diaphragm-connection portion 134 attaching to a top surface of the diaphragm 150, but the diaphragm-connection portion 134 may additionally or alternatively connect to a side surface and/or a bottom surface of the diaphragm 150.

The multi-functional seal component 130 may be formed of a flexible material, such as an elastomer, such that the above-discussed portions of the multi-functional seal component 130 are provided by a unitary elastomer structure. Implementing the multi-functional seal component 130 as a unitary structure eliminates potential ingress of fluids into a transducer that could otherwise occur between a seal and a surround that are implemented as separate components.

The unitary elastomer structure may be formed in a mold and later adhered to the peripheral support structure 170, or the unitary elastomer structure may be molded onto the peripheral support structure 170. In some implementations, an initially-molded portion of the unitary elastomer structure is molded onto the diaphragm 150 and then a remainder of the unitary elastomer structure is molded to the initially-molded portion and the peripheral support structure 170 (e.g., at different stations of an injection molding machine).

The transducer 100 includes a magnetic circuit 180 that forms a closed loop path of magnetic flux. The magnetic circuit 180 that is illustrated in FIG. 1A includes permanent side magnets 184a-b and a center magnet 184c that generate the magnetic flux. A front plate 182 of ferromagnetic material (including outer front plate portions 182a-b and a center front plate portion 182c) and a back plate 184 of ferromagnetic material form a magnetic core that at least partially confines the path of magnetic flux. The ferromagnetic material may be a metal. The magnetic circuit 180 is implemented using permanent magnets, but may be implemented with electromagnets. The magnetic circuit may be implemented with fewer magnets, such as only the side magnets 184a-b, or only the center magnet 184c.

The magnetic circuit 180 defines an air gap 188, illustrated in FIG. 1B by air gap portion 188a and air gap portion 188b. The magnetic circuit 180 directs the magnetic flux through the air gap 188. The air gap 188 may form a closed curving shape (e.g., a racetrack shape), such that air gap portion 188a and air gap portion 188b illustrated in FIG. 1B represent different portions of the air gap 188.

The diaphragm 150 is suspended in air above the magnetic circuit 180 by the surround portion 136 of the multi-functional seal component 130. The diaphragm 150 may be formed of a semi-rigid material or a rigid material (e.g., a plastic, a metal such as aluminum, magnesium, beryllium, or alloyed combination, or a composite such as ceramic, fiberglass, or carbon fiber material).

Attached to the diaphragm 150 is a voice coil 160. The voice coil 160 may include a coil of conductive wire, with positive and negative leads (not shown in the figures) extending therefrom for connection to a source of electrical energy, such as an amplifier that generates an alternating current signal that drives the transducer 100. Suitable conductors include copper, aluminum, silver, or other metals used purely or in combination by alloy or mechanical cladding of a combination thereof. The voice coil 160 may extend into the air gap 188 and surround the center front plate portion 182c and the center magnet 184c. The voice coil 160 may attach directly to the diaphragm 150 or indirectly via one or more other structures, such as coil coupling component 162.

In some implementations, coil coupling component 162 represents an additional voice coil with a different winding density than the voice coil 160 and with a separate set of leads. In some implementations, the additional voice coil is located between the coil coupling component 162 and the voice coil 160. A user device into which the transducer 100 is located may be configured to activate the additional voice coil responsive to detecting that the diaphragm 150 has bottomed out or is operating with characteristics that suggest the presence of water trapped in a space 114 between the mesh 110 and the diaphragm 150. Activating the additional voice coil, in conjunction with activating the voice coil 160, may provide a “boost” that helps the diaphragm 150 recover to its rest state and/or clear water from the space 114 between the mesh 110 and the diaphragm 150.

The transducer 100 includes a barometric vent 164 placed atop the diaphragm 150, and located over an aperture 166 that is defined by the diaphragm. The vent 164, in conjunction with the aperture 166 in the diaphragm, permits air to flow into an internal space 116 of the transducer 100 (e.g., a space that includes the air gap 188 and space between the diaphragm 150 and the magnetic circuit 180). The internal space 116 may otherwise be sealed to air ingress and egress, such that vent 164 (or multiple such vents 164 located across the diaphragm 150) may be an only passage(s) for air to flow into or out of the internal space 116.

The barometric vent 164 may be structured to prevent passage of water there through, for example, at water pressures of 5 bars and lower, 8 bars and lower, 10 bars and lower, or 12 bars and lower. As such, the presence of the vent 164 and the multi-functional seal component 130 together prevent liquids from entering the internal space 116. The vent 164 may be formed of expanded polytetrafluoroethylene (PTFE), which includes layers of nodes and fibrils configured to permit air passage and limit water passage. A time constant of the vent 164 to equalize pressure between the internal space 116 and external atmospheric pressure may be longer than a minute (e.g., a time to equalize 1.2 bars of internal pressure with 1 bar of external atmospheric pressure).

The diaphragm-connection portion 138 of the multi-functional seal component 130 may extend across the diaphragm 150 and contact the vent 164. For example, the diaphragm-connection portion 138 may be molded to sides and/or a top of the vent 164 to retain the vent 164 in position aligned with the aperture 166 in the diaphragm 150.

In some examples, the diaphragm-connection portion 138 may not extend to the vent 164, with the diaphragm-connection portion 138 and the vent 164 being separately bonded to the diaphragm 150, leaving a portion of the diaphragm 150 exposed to space 114. Still, liquid may be unable to pass through any of the diaphragm-connection portion 138, the diaphragm 150, and the vent 164.

In some examples, the vent 164 is attached to an underside of the diaphragm 150. In some examples, the diaphragm 150 does not define any such aperture 166, and the vent 164 is positioned elsewhere within the transducer 100, for example, to permit air to flow into and out of the internal space 116 via a passage into the internal space 116 that is entirely located below the seal portion 132 (e.g., an opening in the bottom of the transducer or a side of the transducer).

FIG. 1C shows a side sectional view of the transducer 100, with the sectional view passing through a long axis of the transducer 100, as illustrated by the reference line in FIG. 1A that is labelled “FIG. 1C”. The side sectional view in FIG. 1C illustrates many of the same components that are presented in FIG. 1B, and such components are labelled with the same reference numbers.

Differences between the FIG. 1C “long” side sectional view and the FIG. 1B “short” side sectional view include the FIG. 1C view showing only the center front pate portion 182c of the front plate 182, and only the center magnet 182c, when viewed through the center of the long axis. Another difference is that the magnetic circuit 180 is bounded by an end frame 172 when viewed along the long axis. The end frame 172 includes a first end frame portion 172a and a second end-frame portion 172b. The end frame 172 is attached to and supports various components of the transducer 100, including the front plate 182, the magnets 184a-c, the back plate 184, and the peripheral support structure 170.

Another difference is that the FIG. 1C side sectional view shows a secondary suspension 122. The secondary suspension 122 includes a first secondary suspension component 122a and a second secondary suspension component 122b. Each of these secondary suspension components 122a-b may be a spring with a first side contacting a bottom surface of the frame 122 and an opposite second side connected to a portion of the voice coil 160. The secondary suspension 122 is configured to impart an additional returning force to diaphragm 150 (in addition to that provided by the surround portion 136) when the diaphragm oscillates away from a rest position, such as the rest position illustrated in FIG. 1B-C.

FIG. 1D shows a top sectional view of the transducer 100, with the sectional view passing through the transducer at a location of the front plate 182, as illustrated by the reference line in FIG. 1C that is labelled “FIG. 1D”. The top sectional view of FIG. 1D illustrates how the voice coil 160 and the air gap 188 each form a continuous closed loop. The top sectional view of FIG. 1D also illustrates how the end frame 172 retains the outer front plate portions 182a-b.

FIG. 2A shows a side sectional view of the transducer 100 being inserted into a recess 194 of a housing 192. The housing 192 may be a housing of a computerized device (e.g., a smart watch, smart glasses, tracker device, mobile phone, or other user device) into which the transducer is located during operation of the transducer 100. FIG. 2A illustrates how the recess 194 is sized slightly larger than an outer perimeter of a portion of the transducer that is below the seal portion 132. As the transducer 100 is inserted into the recess 194, the inner wall 196 of the recess 194 contacts a flexible lip of the seal portion 132 and forces the flexible lip to move inward, as illustrated by the curved arrows in FIG. 2A.

FIG. 2B shows the transducer 100 after insertion into the recess 194, in an installed position. When the transducer 100 is in the installed position, the flexible lip of the seal portion 132 may be retained by the inner wall 196 of the recess 194 in a compressed state, where an amount of compression is in a range of 10% to 30%. When the seal portion 132 is in the compressed state, the flexible lip of the seal portion 132 may be pressed up against an outer peripheral surface of the mesh-supporting component 120.

When the seal portion 132 is in the compressed state, an outer periphery of the seal portion 132 is wider than the outer periphery of the portion of the transducer 100 that is below the seal portion 132. The flexible lip of the seal portion 132 may contact the inner wall 196 of the recess 194 entirely around the transducer 100, to form a continuous seal between the transducer 100 and the housing 192. In some implementations, the recess 194 includes one or more openings in addition to the top opening illustrated in FIGS. 2A-B. In other words, the recess may be defined only by one or more side walls sized to receive the transducer 100 and laterally retain the transducer. The housing 192 may include electrical terminals adapted to receive leads that extend from the voice coil 160.

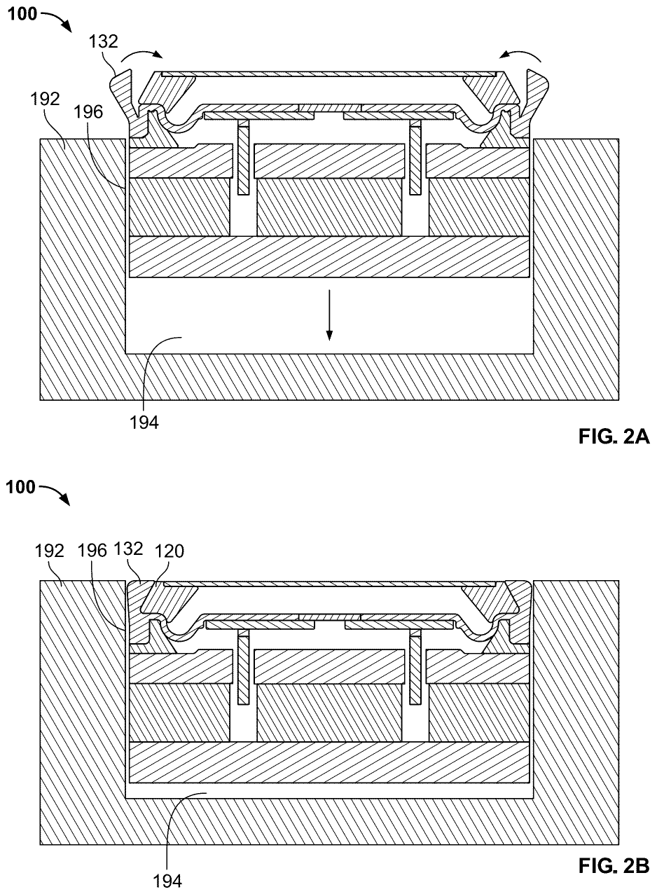

FIG. 3A shows a side sectional view of a transducer 200 being inserted into a recess 294 of a housing 292. The transducer 200 is similar to the transducer 100 in many respects, with a difference being that transducer 200 includes a seal portion 232 which includes a downward-facing lip, rather than an upward-facing lip as with transducer 100.

The downward-facing lip of seal portion 232 facilitates insertion into the recess 294, which is adapted to receive the transducer 200 via insertion from underneath the housing 292 (e.g., with mesh 210 leading the insertion of transducer 200, in contrast to the bottom plate 186 leading the insertion of transducer 100). As with the sealing structures of transducer 100, the downward-facing lip of the seal portion 232 is biased away from a center of the transducer 200. As the transducer 200 is inserted into the recess 294, the inner wall 296 of the recess 294 contacts a flexible lip of the seal portion 232 and forces the flexible lip to move inward, as illustrated by the curved arrows in FIG. 3A.

FIG. 3B shows the transducer 200 after insertion into the recess 294, in an installed position. When the transducer 200 is in the installed position, the flexible lip of the seal portion 232 may be retained by the inner wall 296 of the recess 294 in a compressed state. When the seal portion 232 is in the compressed state, the flexible lip of the seal portion 232 may be pressed up against an outer peripheral surface of the mesh-supporting structure 220 (formed integrally with the multi-functional seal component 230 in transducer 200, rather than being implemented as a separate component).

When the seal portion 232 is in the compressed state, an outer periphery of the seal portion 232 may be wider than the outer periphery of the portion of the transducer 200 that is below the seal portion 232. The flexible lip of the seal portion 232 may contact the inner wall 296 of the recess 294 entirely around the transducer 200, to form a continuous seal between the transducer 200 and the housing 292.

The transducer 200 is similar in many respects to the transducer 100 of FIGS. 1A-2B, with the reference numbers in the figures employing a nomenclature in which: (1) the first digit of each reference number references the transducer embodiment (e.g., embodiment “1” or embodiment “2”), and (2) the last two digits reference the component type. As such, reference numbers that end in the same two digits represent the same type of component in the different transducer embodiments.

Although this discussion does not name every component of transducer 200, the above-referenced nomenclature enables identification of various components that are labelled in FIGS. 3A-B with reference numbers. As an example, item 250 shares the same trailing digits as diaphragm 150, such that item 250 is the diaphragm of transducer 200. Some component types have different structures between the different transducer embodiments, such as the surround portion 236 having a downward-facing concave surface, in distinction to surround portion 136 having an upward-facing concave surface. These different structures are discussed in additional detail below with reference to the close-up sectional views.

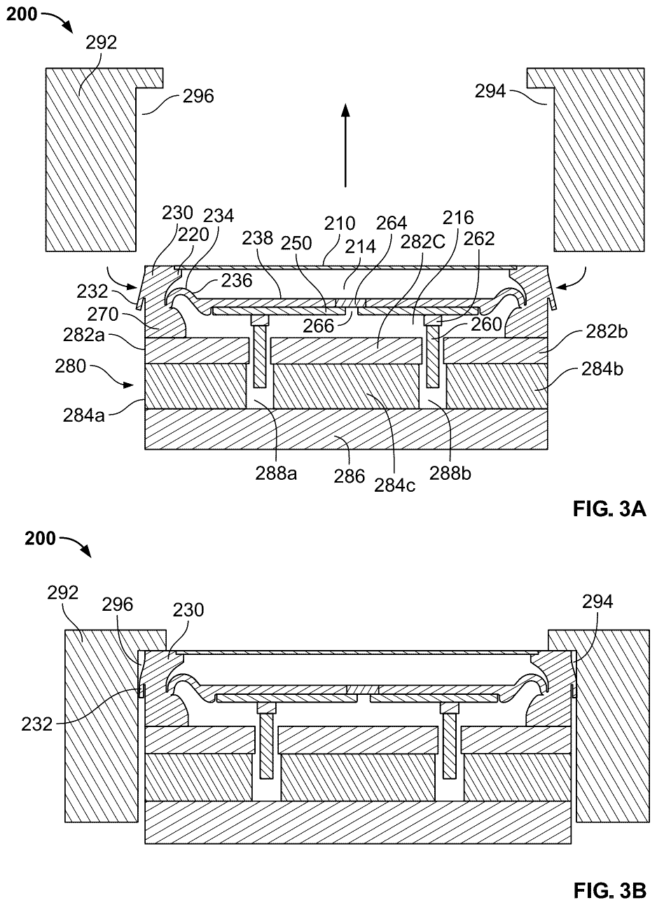

FIGS. 4-6 show close-up sectional views of transducer 100 (FIG. 4), transducer 200 (FIG. 5), and a third transducer 300 (FIG. 6). As with FIGS. 3A-B, components of a same type are labelled with reference numbers that share a last two digits (including reference numbers for transducer 300, and transducers 400 and 500 introduced in subsequent figures), despite this discussion not specifically naming each such component.

Transducer 300 (FIG. 6) differs from transducer 100 (FIG. 4) due to the transducers having landing surfaces with different shapes. For example, the upper and lower landing surfaces 121 and 123 of transducer 100 each include a central section that is straight. In contrast, the upper and lower landing surfaces 321 and 323 of transducer 300 each have curving central sections. Indeed, the upper and lower landing surfaces 321 and 323 are curved across their entirety. All landing surface shapes shown in the various figures are adapted to receive their respective surround portions, as the surround portions “unroll” due to oscillation of the diaphragms 150 and 350. As a result, the surround portions 136 and 236 each include a portion thereof that is: (1) suspended in free air while the surround portions are in their resting states (as illustrated in FIGS. 4 and 6), but that (2) contacts the respective upper and lower landing surfaces responsive to oscillation of the diaphragms 150 and 350.

Transducers 100 and 300 also differ, as a result of the surround portion 136 contacting a greater amount of the lower landing surface 123 during the resting state, in comparison to an amount of the lower landing surface 323 that the surround portion 336 contacts during the resting state. A shape of the lower landing surface 323 proximate the front plate 382 provides a shelf that results in a relatively-greater amount of the surround portion 336 remaining suspended in air when the diaphragm 350 is driven inward toward the front plate 182, in comparison to the shape of the lower landing surface 123 of transducer 100. Similarly, a shape of the upper landing surface 321 proximate the mesh 310 provides another shelf that provides similar functionality when the surround portion 336 is driven outward away from the front plate 182, in comparison to the shape of the upper landing surface 121 of transducer 100.

Transducers 100 and 300 also differ, as a result of differently-shaped lower stopping surfaces 181 and 381 provided by front plates 182 and 382. Each of the lower stopping surfaces 181 and 381 define a step that extends forward away from a remainder of the front plates 182 and 382, with the steps adapted to serve as stops when the diaphragms 150 and 350 are driven toward the front plates 182 and 382 with force that exceeds that imparted by the voice coils of the respective transducers.

The lower stopping surface 181 of transducer 100 is shaped to receive both the surround portion 136 and the diaphragm 150 when the diaphragm is driven with excessive force toward the front plate 182. In contrast, the shape of the landing surface 323 and the lower stopping surface 381 in transducer 300 results in the top surface 381 receiving only the diaphragm 350 when the diaphragm 350 is driven with excessive force toward the front plate 182. An end of the surround portion 336 proximate the diaphragm 350 remains suspended in air without contacting the lower stopping surface 381 when the diaphragm is driven with excessive force toward the front plate 182.

A shape of the lower stopping surface 281 of transducer 200 (FIG. 5) is flat, in distinction to the shape of the lower stopping surfaces 181 and 381 of transducers 100 and 300. As a result, the lower stopping surface 281 is adapted to provide a stop that receives both diaphragm 250 and a protrusion 239 of the multi-functional seal component. All transducer embodiments referenced in this disclosure may implement any one of the top surface configurations illustrated in FIGS. 4-6.

Transducer 200 has a surround portion 236 that curves opposite that of transducers 100 and 300, such that the concave surface of surround portion 236 faces toward the magnetic circuit rather than away from the magnetic circuit. As a result, the upper and lower landing surfaces 221 and 223 are shaped differently from those of transducers 100 and 300. While the upper and lower landing surfaces 221 and 223 include center sections that curve, the upper and lower landing surfaces 221 and 223 may be implemented with center sections that are straight, as with transducer 100. All transducer embodiments referenced in this disclosure may implement either the concave-up surround portion configuration of transducer 100 or the concave-down surround portion configuration of transducer 200.

Transducer 200 includes a seal portion that includes a lip 233 that extends downward, toward the magnetic circuit of transducer 200. In contrast, transducers 100 and 300 include lips 133 and 333 that extend upward, away from the magnetic circuits of transducers 100 and 300. Regardless, all such lips 133, 233, and 333 are separated from another portion of their respective transducers by an air gap when the respective transducers are in an uninstalled state. (FIG. 5 shows transducer 200 in an uninstalled state, while FIGS. 4 and 6 show transducers 100 and 300 in installed states.) All transducer embodiments referenced in this disclosure may implement either the lip-up seal configuration of transducer 100 or the lip-down seal configuration of transducer 200.

The multi-functional seal components 130 and 330 are anchored to the peripheral support structures 170 and 270 at anchoring locations 242 and 342. Anchoring locations 242 and 342 may include recesses in the peripheral support structures 170 and 270 into which the elastomer of the multifunctional seal components 130 and 330 may embed during an injection molding process.

The multi-functional seal component 230 of transducer 200 includes a mesh-supporting portion 220 and a peripheral support portion 270 that are integrated with the other components of the multi-functional seal component 230 as a unitary structure (e.g., formed of an elastomer). In contrast, the transducers 100 and 300 include separate components for their respective mesh-supporting components 120 and 320 and their respective peripheral support components 170 and 370. All transducer embodiments referenced in this disclosure may implement its respective mesh-supporting component and peripheral support component as components separate from the respective multi-functional seal component, or with one or both such components integrated with the respective-multi-functional seal component. Moreover, all transducer embodiments referenced in this disclosure may implement the surround portion and the seal portion as distinct, separate components (e.g., formed of different materials and/or physically separated from each other).

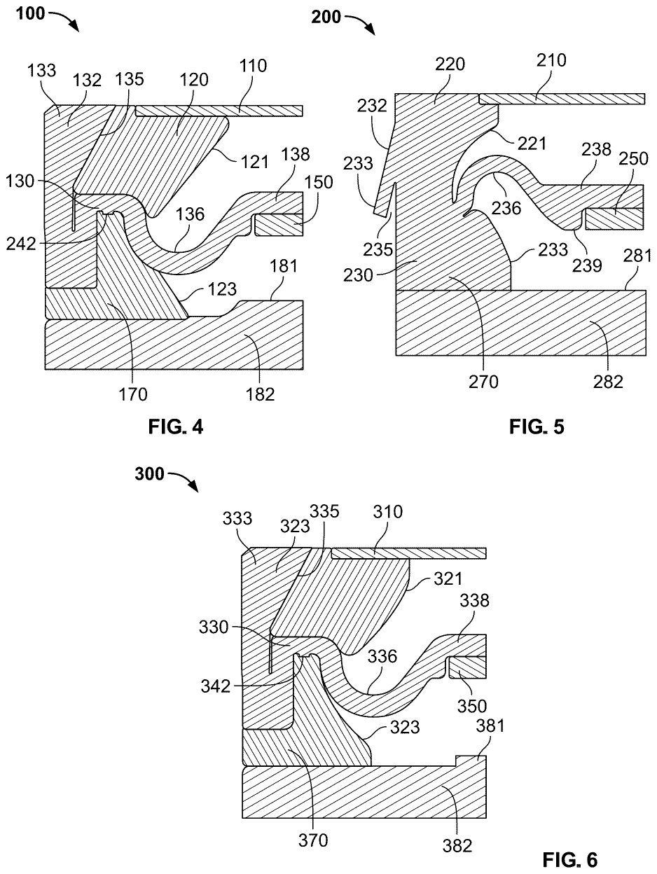

FIG. 7A shows transducer 100 in a state in which the diaphragm 150 has been driven a maximum extent inward toward the magnetic circuit 180, by activation of the voice coil 160 within a configured electro-magnetic operating range of the transducer 100. For example, an amplifier supplying an AC waveform to the voice coil 160 may be configured to supply electrical energy within and limited to a range of negative 15 volts to positive 15 volts peak. Supplying electrical energy at a maximum power afforded within this range may drive the diaphragm 150 toward, but not quite to, the lower stopping surface 181 of the front plate 182, producing the negative excursion of the diaphragm 150 shown in FIG. 7A.

At the maximum negative excursion produced under operation within the configured electro-magnetic operating range of the transducer 100: (1) a gap between the diaphragm 150 and the lower stopping surface 181 at location 142 is between 0.04 mm and 0.1 mm or between 0.06 mm and 0.08 mm; and (2) a gap between the surround portion 136 and the lower stopping surface 181 also exists. In this state, the surround portion 136 has stretched, for example, less than 7 percent, less than 12 percent, or between 8 to less than 12 percent from a rest state of the surround portion 136.

FIG. 7B shows transducer 100 in a state in which the diaphragm 150 has been driven a maximum extent outward from the magnetic circuit 180, due to activation of the voice coil 160. At such a maximum positive excursion produced within the configured electro-magnetic operating range of the transducer 100: (1) a gap between the diaphragm 150 and the upper landing surface 183 provided by the mesh 110 at location 144 is a gap of between 0.04 mm and 0.1 mm or between 0.06 mm and 0.08 mm; and (2) a gap between the surround portion 136 and the upper landing surface 121 exists at location 143. In this state, the surround portion 136 has stretched, for example, less than 7 percent, less than 12 percent, or between 8 to less than 12 percent from a rest state of the surround portion 136.

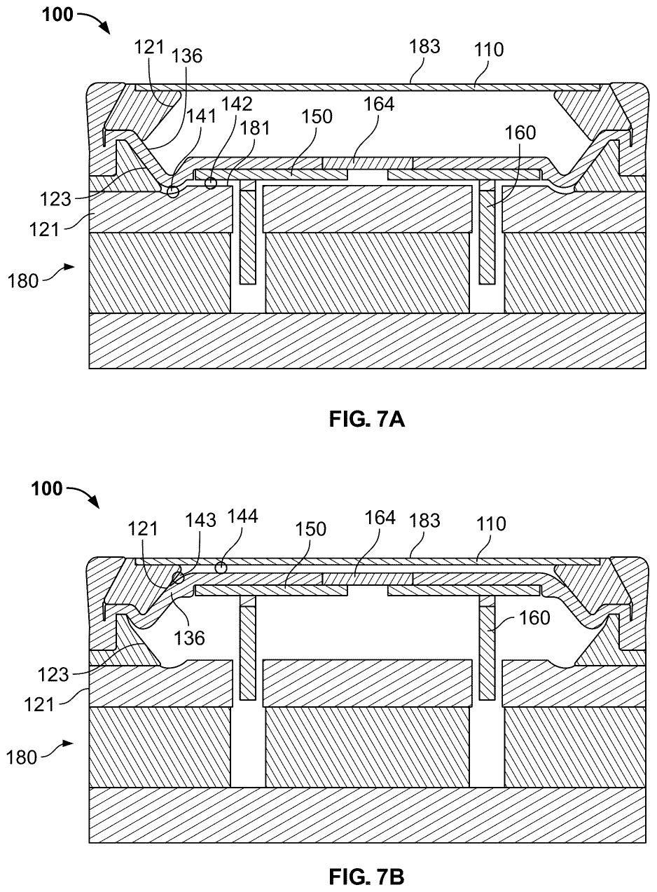

FIG. 8A shows transducer 100 in a state in which the diaphragm 150 has been driven until the diaphragm 150 contacts a lower stopping surface 181 provided by the front plate 121 (e.g., due to liquid being forced through mesh 110 and into space 114). As a result, there is no gap illustrated between the diaphragm 150 and the lower stopping surface at location 142 in FIG. 8A, and there is no gap illustrated between the surround portion 136 and the lower stopping surface 181 at location 141 in FIG. 8A. In this state, the surround portion 136 has stretched between greater than 12 percent and 20 percent from a rest state of the surround portion 136, which is greater than a maximum amount of stretch experienced during operation within the configured electro-magnetic operating range of the transducer 100.

FIG. 8B shows transducer 100 in a state in which the diaphragm 150 has been driven until the diaphragm 150 contacts the upper stopping surface 183 provided by the mesh 110 (e.g., due to a vacuum pressure being applied to the transducer). As a result, there is no gap illustrated between the diaphragm 150 and the upper stopping surface at location 144 in FIG. 8B, and there is no gap illustrated between the surround portion 136 and the upper landing surface 121 at location 143 in FIG. 8B. In this state, the surround portion 136 has stretched between greater than 12 percent and 20 percent from a rest state of the surround portion 136, which is greater than an amount of stretch experienced during operation within the configured electro-magnetic operating range of the transducer 100.

The surround portion 136 of transducer 100 may be configured to provide a linear return force of 0.8 N/mm in some embodiments (and within a range from 0.4 N/mm to 2.0 N/mm in other embodiments), for example, providing a linear spring constant throughout the configured electro-magnetic operating range of the transducer 100 (e.g., such that the return force deviates by no more than 5, 10, 15, 20, 25, or 30 percent across the configured operating range). The additional stretch experienced by the surround portion 136 when the diaphragm 150 is driven to the lower stopping surface 181 produces a relatively-greater return force of 40-50 percent, 45-55 percent, or 50-60 percent greater return force than the linear return force. The additional stretch experienced by the surround portion 136 when the diaphragm 150 is driven to the upper stopping surface 183 produces a relatively-greater return force of 40-50 percent, 45-55 percent, or 50-60 percent greater return force than the linear return force. The increased return forces assist with returning the diaphragm 150 from the limits of its excursion, and can assist clearing liquid that may have collected in space 114.

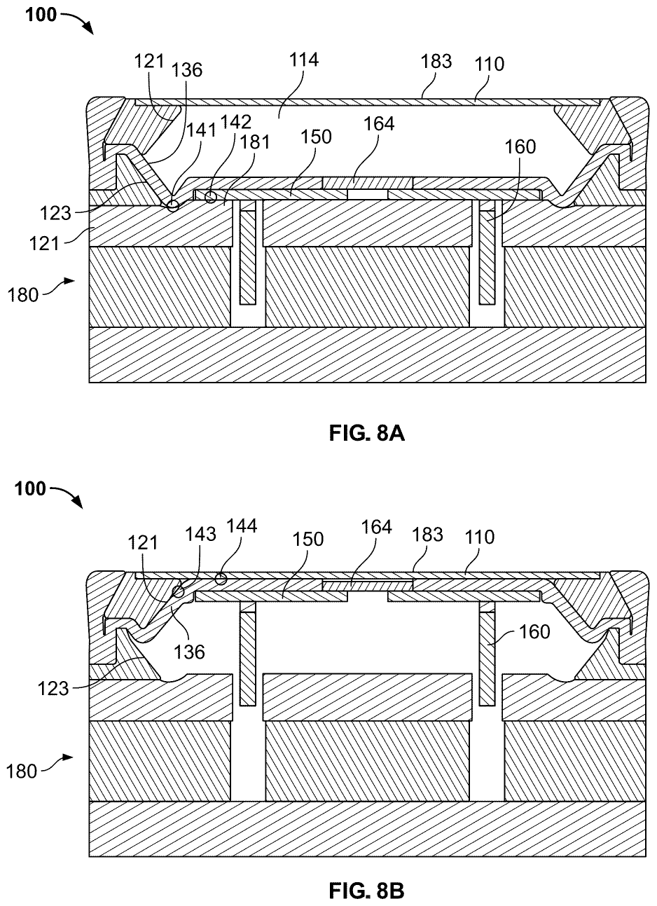

FIG. 9 shows a transducer 400 with a diaphragm that is illustrated as being located at both: (1) its maximum positive excursion under a configured electro-magnetic operating range of the transducer 400 (as shown by diaphragm 450a); and (2) its maximum negative excursion under the configured operating range (as shown by diaphragm 450b). The transducer 400 is similar to transducer 100, with a difference including that the upper landing surface 421 and the lower landing surface 423 each extend toward a center of the diaphragm 450, before extending away from the center of the diaphragm 450 at locations proximate an upper stopping surface 483 and a lower stopping surface 181. These shapes for the landing surfaces result in a relatively-larger part of the surround portions 436a, 436b being suspended in air along with the diaphragm 450. All transducer embodiments referenced in this disclosure may implement the landing surface shapes illustrated in FIG. 9.

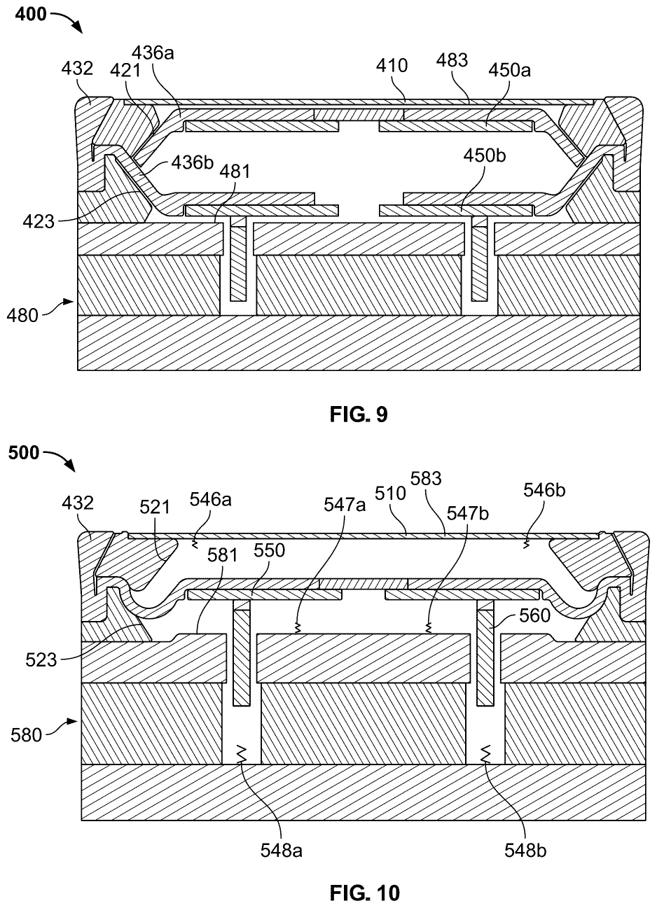

FIG. 10 shows a transducer 500 that is similar to transducer 100, but that includes various additional suspension components. A first set of suspension components 548a-b function similar to the secondary suspension 122a-b illustrated in FIG. 1C, except that the first set of suspension components 548a-b are not connected to the voice coil 560 when the diaphragm 550 and voice coil 560 are in their rest state. Rather, the voice coil 560 may only contact the first set of suspension components 548a-b and compress the first set of suspension components when the diaphragm 550 is driven to near the lower stopping surface 581. The first set of suspension components 548a-b therefore assists the diaphragm 550 in returning to its rest state.

A second set of suspension components 547a-b are located on and extend from the lower stopping surface 581. This second set of suspension components provide a similar function, except that the second set of suspension components 547a-b are adapted to contact the diaphragm 550 instead of the voice coil 560.

A third set of suspension components 546a-b are located on and extend from the upper stopping surface 583. This third set of suspension components 546a-b provide a similar function to the above-described suspension components, except that the third set of suspension components are adapted to contact portions of the multi-functional seal component 130. Also, the third set of suspension components are adapted to provide an additional return force from a positive excursion, while the first and second sets of suspension components 548a-b and 547a-b are adapted to provide an additional return force from a negative excursion.

Each set of suspension components 546a-b, 547a-b, and 548a-b may include one or more springs, or one or more other mechanisms that provide a return force when compressed (e.g., a compressive elastomer). All transducer embodiments described in this disclosure may be implemented with any combination of one or more of the suspensions illustrated in FIGS. 1C and 10.

As additional description to the embodiments described above, the present disclosure describes the following embodiments.

Embodiment A1 is an electroacoustic transducer, comprising: a magnetic circuit that defines an air gap; a diaphragm; a voice coil that is attached to the diaphragm and extends into the air gap defined by the magnetic circuit; and multi-functional seal component that includes: (i) a seal portion that is adapted to compress and form a seal between the electroacoustic transducer and a housing when the electroacoustic transducer has been placed into a recess of the housing that sized to receive the electroacoustic transducer; and (ii) a surround portion that is flexible and connects the diaphragm to a peripheral support structure of the electroacoustic transducer, to provide suspension for the diaphragm and enable the diaphragm to oscillate responsive to electrical activation of the voice coil.

Embodiment A2 is the electroacoustic transducer of embodiment A1, wherein the multi-functional seal component is formed of an elastomer material, such that the seal portion of the multi-functional seal component and the surround portion of the multi-functional seal component are provided by a unitary structure that is formed of the elastomer material.

Embodiment A3 is the electroacoustic transducer of any one of embodiments A1 and A2, wherein the seal portion of the multi-functional seal component includes a lip that is separated from an other portion of the electroacoustic transducer by an air gap, with the lip being adapted to flex and contact the other portion of the electroacoustic transducer responsive to the electroacoustic transducer being placed into the recess of the housing that is sized to receive the electroacoustic transducer.

Embodiment A4 is the electroacoustic transducer of embodiment A3, wherein the other portion of the electroacoustic transducer is an other part of the seal portion, such that the seal portion defines a channel that is adapted to close as the lip flexes toward the other part of the seal portion as a result of contact from the housing responsive to the electroacoustic transducer being placed into the recess of the housing that is sized to receive the electroacoustic transducer.

Embodiment A5 is the electroacoustic transducer of any one of embodiments A1-4, wherein the seal portion defines an outermost periphery to the electroacoustic transducer along an lateral axis that is transverse to a vertical axis in which the diaphragm is adapted to oscillate responsive to electrical activation of the voice coil.

Embodiment A6 is the electroacoustic transducer of any one of embodiments A1-5, wherein: the seal portion of the multi-functional seal component completely surrounds a center of the diaphragm; and the surround portion of the multi-functional seal component completely surrounds the center of the diaphragm.

Embodiment A7 is the electroacoustic transducer of embodiment A1, wherein: the diaphragm defines a diaphragm aperture; the electroacoustic transducer comprises a barometric vent that is attached to the diaphragm such that the barometric vent is adapted to oscillate with the diaphragm responsive to electrical activation of the voice coil; and the barometric vent is structured to enable air to pass through the barometric vent and the diaphragm aperture to equalize a barometric pressure between an internal space of the electroacoustic transducer and atmospheric pressure.

Embodiment A8 is the electroacoustic transducer of embodiment A7, wherein: the barometric vent is structured to prevent water from passing through the barometric vent; the multi-functional seal component surrounds the barometric vent and is structured to prevent water from: (i) entering the internal space of the electroacoustic transducer; and (ii) passing between the electroacoustic transducer and the housing, when the electroacoustic transducer has been placed into the recess of the housing sized to receive the electroacoustic transducer.

Embodiment A9 is the electroacoustic transducer of any one of embodiments A7-8, wherein: the diaphragm aperture is located at a center of the diaphragm; and the barometric vent is aligned with the center of the diaphragm.

Embodiment A10 is the electroacoustic transducer of any one of embodiments A7-9, wherein a time constant of the barometric vent is longer than a minute.

Embodiment A11 is the electroacoustic transducer of any one of embodiments A7-10, wherein the diaphragm comprises a rigid structure.

Embodiment A12 is the electroacoustic transducer of any one of embodiments A1-11, wherein the multifunctional seal component includes the peripheral support structure, such that the seal portion, the surround portion, and the peripheral support structure provided by a unitary structure formed of elastomer material.

Embodiment A13 is the electroacoustic transducer of any one of embodiments A1-12, wherein the magnetic circuit includes: a ferromagnetic front plate that includes a center front plate portion located inside the voice coil and an outer front plate portion located outside the voice coil; a ferromagnetic back plate; an outer magnet that is located between the ferromagnetic front plate and the ferromagnetic back plate, and that is located outside the voice coil; and a center magnet that is located between the ferromagnetic front plate and the ferromagnetic back plate, and that is located inside the voice coil.

Embodiment A14 is the electroacoustic transducer of any one of embodiments A1-12, including any additional features recited by embodiments B1-22, below.

Embodiment B1 is an electroacoustic transducer, comprising: a magnetic circuit that defines an air gap; a diaphragm; a voice coil that is attached to the diaphragm and extends into the air gap defined by the magnetic circuit; a peripheral support structure; a surround that is flexible and connects the diaphragm to the peripheral support structure, to provide suspension for the diaphragm and enable the diaphragm to oscillate responsive to electrical activation of the voice coil, wherein the surround and the peripheral support structure are shaped such that a portion of the surround that is suspended in air when the diaphragm is in a rest state comes into contact with a lower landing surface of the peripheral support structure when the diaphragm oscillates responsive to electrical activation of the voice coil.

Embodiment B2 is the electroacoustic transducer of embodiment B1, comprising: a lower stopping surface that is located above the magnetic circuit and that the diaphragm is adapted to contact responsive to fluid driving the diaphragm toward the magnetic circuit.

Embodiment B3 is the electroacoustic transducer of embodiment B2, wherein: the electroacoustic transducer is configured such that the diaphragm oscillates without coming into contact with the lower stopping surface responsive to electrical activation of the voice coil; and the diaphragm is adapted to contact the lower topping surface in a non-destructive manner responsive to fluid driving the diaphragm toward the magnetic circuit with a force that exceeds that capable of being imparted upon the diaphragm by the voice coil due to electrical activation of the voice coil.

Embodiment B4 is the electroacoustic transducer of embodiment B3, wherein the force that exceeds that capable of being imparted upon the diaphragm by the voice coil due to electrical activation of the voice coil is a force of at least four bars of pressure.

Embodiment B5 is the electroacoustic transducer of any one of embodiments B2-4, wherein: the surround is adapted to stretch less than a threshold amount of stretch when the diaphragm oscillates responsive to electrical activation of the voice coil; and the surround is adapted to stretch more than the threshold amount of stretch when the diaphragm is driven toward the magnetic circuit responsive to fluid driving the electroacoustic transducer toward the magnetic circuit.

Embodiment B6 is the electroacoustic transducer of any one of embodiments B3-5, wherein: the surround is formed of an elastomer material; and an amount that the surround is adapted to stretch until the surround contacts the lower stopping surface, responsive to fluid driving the diaphragm toward the magnetic circuit, remains below a second threshold amount of stretch that results in viscoelastic creep to the surround that at least semi-permanently stretches the surround an amount that affects transducer sound quality for at least a minute.

Embodiment B7 is the electroacoustic transducer of embodiment B6, wherein: the threshold amount of stretch that the surround is adapted to stretch when the diaphragm oscillates responsive to electrical activation of the voice coil is less than 7 percent; and the amount that the surround is adapted to stretch until the surround contacts the lower stopping surface, responsive to fluid driving the diaphragm toward the magnetic circuit, is between 12 and 20 percent.

Embodiment B8 is the electroacoustic transducer of any one of embodiments B3-7, wherein: the surround is adapted to provide a linear spring constant return force to the diaphragm responsive electrical activation of the voice coil within an electro-magnetic operating range of the electroacoustic transducer; and the surround is adapted to provide a return force greater than the linear spring constant return force responsive to fluid driving the diaphragm toward the magnetic circuit until the diaphragm contacts the lower stopping surface.

Embodiment B9 is the electroacoustic transducer of any one of embodiments B1-8, wherein: the surround connects to the peripheral support structure at a connecting portion of the peripheral support structure; and the lower landing surface of the peripheral support structure is located closer to a center of the electroacoustic transducer than the connecting portion of the peripheral support structure.

Embodiment B10 is the electroacoustic transducer of embodiment B9, wherein the lower landing surface extends inward toward the center of the electroacoustic transducer as the lower landing surface extends from the connecting portion toward the magnetic circuit.

Embodiment B11 is the electroacoustic transducer of any one of embodiments B9-10, wherein: the surround is curved between the peripheral support structure and the diaphragm; the surround contacts a portion of the lower landing surface when the diaphragm is in the rest state; and the surround is adapted to at least partially unroll from being curved as the portion of the surround comes into contact with the lower landing surface when the diaphragm oscillates responsive to electrical activation of the voice coil.

Embodiment B12 is the electroacoustic transducer of any one of embodiments B1-11, comprising: a mesh positioned opposite the diaphragm from the magnetic circuit, to provide dust ingress protection for the electroacoustic transducer, wherein the mesh is attached to a remainder of the electroacoustic transducer such that that the mesh remains stationary relative to the magnetic circuit when the diaphragm oscillates responsive to electrical activation of the voice coil.

Embodiment B13 is the electroacoustic transducer of any one of embodiments B1-12, comprising: an upper landing surface located opposite the surround from the magnetic circuit, wherein the surround and the upper landing surface are shaped such that the portion of the surround that is suspended in air when the diaphragm is in the rest state comes into contact with the upper landing surface when the diaphragm oscillates responsive to electrical activation of the voice coil.

Embodiment B14 is the electroacoustic transducer of embodiment B13, wherein the upper landing surface extends inward toward a center of the electroacoustic transducer as the upper landing surface extends from the surround and away from the magnetic circuit.

Embodiment B15 is the electroacoustic transducer of embodiment B14, wherein: the surround is curved between the peripheral support structure and the diaphragm; the surround is adapted to at least partially unroll from being curved as the portion of the surround comes into contact with the upper landing surface when the diaphragm oscillates responsive to electrical activation of the voice coil.

Embodiment B16 is the electroacoustic transducer of any one of embodiments B13-15, comprising: a mesh positioned opposite the diaphragm from the magnetic circuit, to provide dust ingress protection for the electroacoustic transducer, wherein the mesh provides an upper stopping surface that is adapted to limit movement of the diaphragm away from the magnetic circuit responsive to a negative pressure force acting upon the diaphragm to move the diaphragm away from the magnetic circuit.

Embodiment B17 is the electroacoustic transducer of any one of embodiments B13-16, comprising: a mesh positioned opposite the diaphragm from the magnetic circuit, to provide dust ingress protection for the electroacoustic transducer, wherein the upper landing surface is provided by a mesh-supporting component that supports the mesh.

Embodiment B18 is the electroacoustic transducer of embodiment 17, wherein the mesh-supporting component that is formed from an elastomer that is integrally formed with the surround.

Embodiment B19 is the electroacoustic transducer of any one of embodiments B17-18, wherein: the mesh-supporting component is distinct from the surround; and the mesh-supporting component is located opposite the surround from the peripheral support structure that provides the lower landing surface.

Embodiment B20 is the electroacoustic transducer of any one of embodiments B1-19, wherein the magnetic circuit includes: a ferromagnetic front plate that includes a center front plate portion located inside the voice coil and an outer front plate portion located outside the voice coil; a ferromagnetic back plate; an outer magnet that is located between the ferromagnetic front plate and the ferromagnetic back plate, and that is located outside the voice coil; and a center magnet that is located between the ferromagnetic front plate and the ferromagnetic back plate, and that is located inside the voice coil.

Embodiment B21 is the electroacoustic transducer of any one of embodiments B1-20, comprising: a secondary suspension that is located within the air gap that is defined by the magnetic circuit, wherein the secondary suspension is adapted to provide a returning force to the diaphragm responsive to the diagram moving toward the magnetic circuit.

Embodiment B22 is the electroacoustic transducer of embodiment B21, wherein the secondary suspension is attached to a portion of the voice coil that is located in the air gap when the diaphragm is in the rest state, and remains attached to the portion of the voice coil that is located in the air gap when the diaphragm oscillates responsive to electrical activation of the voice coil.

Embodiment B23 is the electroacoustic transducer of any one of embodiments B1-22, including any additional features recited by embodiments A1-13.

Although a few implementations have been described in detail above, other modifications are possible. Moreover, other mechanisms for performing the systems and methods described in this document may be used. In addition, the operations depicted in the figures do not require the particular order shown, or sequential order, to achieve desirable results. Other steps may be provided, or steps may be eliminated, from the described processes, and other components may be added to, or removed from, the described systems. Accordingly, other implementations are within the scope of the following claims.

1. An electroacoustic transducer, comprising:
a magnetic circuit that defines an air gap;
a diaphragm;
a voice coil that is attached to the diaphragm and extends into the air gap defined by the magnetic circuit;
a peripheral support structure; and
a surround that is flexible and connects the diaphragm to the peripheral support structure, to provide suspension for the diaphragm and enable the diaphragm to oscillate responsive to electrical activation of the voice coil, wherein the surround and the peripheral support structure are shaped such that a portion of the surround that is suspended in air when the diaphragm is in a rest state comes into contact with a lower landing surface of the peripheral support structure when the diaphragm oscillates responsive to electrical activation of the voice coil.

2. The electroacoustic transducer of claim 1, comprising:
a lower stopping surface that is located above the magnetic circuit and that the diaphragm is adapted to contact responsive to fluid driving the diaphragm toward the magnetic circuit.

3. The electroacoustic transducer of claim 2, wherein:
the electroacoustic transducer is configured such that the diaphragm oscillates without coming into contact with the lower stopping surface responsive to electrical activation of the voice coil; and
the diaphragm is adapted to contact the lower topping surface in a non-destructive manner responsive to fluid driving the diaphragm toward the magnetic circuit with a force that exceeds that capable of being imparted upon the diaphragm by the voice coil due to electrical activation of the voice coil.

4. The electroacoustic transducer of claim 3, wherein the force that exceeds that capable of being imparted upon the diaphragm by the voice coil due to electrical activation of the voice coil is a force of at least four bars of pressure.

5. The electroacoustic transducer of claim wherein:
the surround is adapted to stretch less than a threshold amount of stretch when the diaphragm oscillates responsive to electrical activation of the voice coil; and
the surround is adapted to stretch more than the threshold amount of stretch when the diaphragm is driven toward the magnetic circuit responsive to fluid driving the electroacoustic transducer toward the magnetic circuit.

6. The electroacoustic transducer of claim 3, wherein:
the surround is formed of an elastomer material; and
an amount that the surround is adapted to stretch until the surround contacts the lower stopping surface, responsive to fluid driving the diaphragm toward the magnetic circuit, remains below a second threshold amount of stretch that results in viscoelastic creep to the surround that at least semi-permanently stretches the surround an amount that affects transducer sound quality for at least a minute.

7. The electroacoustic transducer of claim 6, wherein:
the threshold amount of stretch that the surround is adapted to stretch when the diaphragm oscillates responsive to electrical activation of the voice coil is less than 7 percent; and
the amount that the surround is adapted to stretch until the surround contacts the lower stopping surface, responsive to fluid driving the diaphragm toward the magnetic circuit, is between 12 and 20 percent.

8. The electroacoustic transducer of claim 3, wherein:
the surround is adapted to provide a linear spring constant return force to the diaphragm responsive electrical activation of the voice coil within an electro-magnetic operating range of the electroacoustic transducer; and
the surround is adapted to provide a return force greater than the linear spring constant return force responsive to fluid driving the diaphragm toward the magnetic circuit until the diaphragm contacts the lower stopping surface.

9. The electroacoustic transducer of claim 1, wherein:
the surround connects to the peripheral support structure at a connecting portion of the peripheral support structure; and
the lower landing surface of the peripheral support structure is located closer to a center of the electroacoustic transducer than the connecting portion of the peripheral support structure.

10. The electroacoustic transducer of claim 9, wherein the lower landing surface extends inward toward the center of the electroacoustic transducer as the lower landing surface extends from the connecting portion toward the magnetic circuit.

11. The electroacoustic transducer of claim 9, wherein:
the surround is curved between the peripheral support structure and the diaphragm;
the surround contacts a portion of the lower landing surface when the diaphragm is in the rest state; and
the surround is adapted to at least partially unroll from being curved as the portion of the surround comes into contact with the lower landing surface when the diaphragm oscillates responsive to electrical activation of the voice coil.

12. The electroacoustic transducer of claim 1, comprising:
a mesh positioned opposite the diaphragm from the magnetic circuit, to provide dust ingress protection for the electroacoustic transducer,
wherein the mesh is attached to a remainder of the electroacoustic transducer such that that the mesh remains stationary relative to the magnetic circuit when the diaphragm oscillates responsive to electrical activation of the voice coil.

13. The electroacoustic transducer of claim 1, comprising:
an upper landing surface located opposite the surround from the magnetic circuit,
wherein the surround and the upper landing surface are shaped such that the portion of the surround that is suspended in air when the diaphragm is in the rest state comes into contact with the upper landing surface when the diaphragm oscillates responsive to electrical activation of the voice coil.

14. The electroacoustic transducer of claim 13, wherein the upper landing surface extends inward toward a center of the electroacoustic transducer as the upper landing surface extends from the surround and away from the magnetic circuit.

15. The electroacoustic transducer of claim 14, wherein:
the surround is curved between the peripheral support structure and the diaphragm;
the surround is adapted to at least partially unroll from being curved as the portion of the surround comes into contact with the upper landing surface when the diaphragm oscillates responsive to electrical activation of the voice coil.

16. The electroacoustic transducer of claim 13, comprising:
a mesh positioned opposite the diaphragm from the magnetic circuit, to provide dust ingress protection for the electroacoustic transducer,
wherein the mesh provides an upper stopping surface that is adapted to limit movement of the diaphragm away from the magnetic circuit responsive to a negative pressure force acting upon the diaphragm to move the diaphragm away from the magnetic circuit.

17. The electroacoustic transducer of claim 13, comprising:
a mesh positioned opposite the diaphragm from the magnetic circuit, to provide dust ingress protection for the electroacoustic transducer,
wherein the upper landing surface is provided by a mesh-supporting component that supports the mesh.

18. The electroacoustic transducer of claim 17, wherein the mesh-supporting component that is formed from an elastomer that is integrally formed with the surround.

19. The electroacoustic transducer of claim 17, wherein:
the mesh-supporting component is distinct from the surround; and
the mesh-supporting component is located opposite the surround from the peripheral support structure that provides the lower landing surface.

20. The electroacoustic transducer of claim 1, wherein the magnetic circuit includes:
a ferromagnetic front plate that includes a center front plate portion located inside the voice coil and an outer front plate portion located outside the voice coil;
a ferromagnetic back plate;
an outer magnet that is located between the ferromagnetic front plate and the ferromagnetic back plate, and that is located outside the voice coil; and
a center magnet that is located between the ferromagnetic front plate and the ferromagnetic back plate, and that is located inside the voice coil.

21. The electroacoustic transducer of claim 1, comprising:
a secondary suspension that is located within the air gap that is defined by the magnetic circuit,
wherein the secondary suspension is adapted to provide a returning force to the diaphragm responsive to the diagram moving toward the magnetic circuit.

22. The electroacoustic transducer of claim 21, wherein the secondary suspension is attached to a portion of the voice coil that is located in the air gap when the diaphragm is in the rest state, and remains attached to the portion of the voice coil that is located in the air gap when the diaphragm oscillates responsive to electrical activation of the voice coil.
